(19) United States
(12) Patent Application Publication
(10) Pub. No.: US 2019/0158455 A1
(43) Pub. Date: May 23, 2019

(54) AUTOMATIC DNS UPDATES USING DNS COMPLIANT CONTAINER NAMES

(71) Applicant: International Business Machines Corporation, Armonk, NY (US)

(72) Inventors: Harsha Hegde, Buffalo Grove, IL (US); Michael S. Burbey, Golden, CO (US)

(21) Appl. No.: 15/815,766

(22) Filed: Nov. 17, 2017

(51) Int. Cl. H04L 29/12; G06F 17/30; G06F 3/06

(52) U.S. Cl. CPC H04L 61/1511; G06F 3/067; H04L 61/2076; G06F 17/30377

(57) ABSTRACT

A method, system, and computer program product may enforce DNS compliant names for containers in an object storage system to perform automatic DNS updates. A container creation request may be received, and it may be determined whether the container name is DNS compliant. DNS entries may be created according to the DNS compliant container name, and the creation of the DNS entry may include identifying a vault container, identifying a set of DS processing units servicing the vault container, and creating DNS entries that point to the set of DS processing units.

### BACKGROUND

The present disclosure relates generally to the field of object storage systems, and more particularly to naming containers in a dispersed storage network.

In computing environments, data may be managed according to an object-based architecture, where each object may include the data itself, some amount of metadata, and a globally unique identifier. Object storage may be implemented at various levels (e.g., device level, system level, interface level, etc.). Object storage may enable certain capabilities that are unavailable in other architectures (e.g., file system architectures, block architectures, etc.), such as, for example, interfaces that may be directly programmable by an application, a namespace that may span multiple instances of physical hardware (e.g., virtual machines spanning multiple physical systems), and some data management functions including data replication and distribution at an object-level of granularity. Object-based storage systems may allow for the retention of vast amounts of unstructured data, such as images, audio files, etc.

### SUMMARY

Disclosed herein are embodiments of a method, system, and computer program product for performing automatic DNS updates in an object storage system.

A container creation request is received. It is determined that a container name in the container creation request is DNS compliant. One or more DNS entries are created, according to the DNS compliant container name, and the creation includes: identifying a vault container, identifying a set of DS processing units servicing the vault container, and creating DNS entries that point to the set of DS processing units servicing the vault container.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a diagram of an example computing environment in which embodiments of the present disclosure may be implemented.

FIG. 2 illustrates a flowchart of a method for enforcing DNS compliant names for container creation and automatic updates, according to an embodiment of the present invention.

FIG. 3 depicts a cloud computing environment according to an embodiment of the present invention.

FIG. 4 depicts abstraction model layers according to an embodiment of the present invention.

FIG. 5 depicts a high-level block diagram of an example computer system that may be used in implementing embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to object storage systems, and more particularly to naming containers in a dispersed storage network. While the present disclosure is not necessarily limited to such applications, various aspects of the disclosure may be appreciated through a discussion of various examples using this context.

In an object storage system, containers may be created via a representative state transfer (REST/RESTful) interface. RESTful interfaces provide an application program interface (API) between systems using hypertext transfer protocol (HTTP) to obtain data and generate operations on that data in a variety of formats.

In object storage systems, containers may be created using names that are Domain Name System (DNS) compliant or DNS non-compliant. DNS compliant names may be used to route user requests based on the DNS compliant name. To route requests using container names, a DNS server must be updated, either by operations management, or by a client submitting requests.

Conventionally, when a DNS server receives a container creation or other request or update, the DNS entries (e.g., the mapping of internet protocol (IP) addresses to containers) on the DNS server need to be updated manually. This puts significant burdens on the client and operations management. The present disclosure contemplates an object storage system that enforces a policy that ensures its containers are created with, and maintain, DNS compliant names in order to support container name based request routing (e.g. <container name>/host name) or path based request routing (e.g., <host name>/container name). Container name based request routing and path based request routing are desirable for a variety of reasons. For example, an object storage system may perform load balancing and other updates by routing user requests using container names, without the need to manually update the DNS entries at the DNS server.

A dispersed storage network (DSN) enforcing DNS compliant container names may automatically update one or more DNS servers during the processing of a request, such as a container creation request (e.g., a PUT BUCKET request received via a RESTful interface). For example, a dispersed storage (DS) processing unit, upon receiving a PUT BUCKET request, could: check if the desired container name is DNS compliant and reject DNS non-compliant container names; retrieve a list of DNS servers the system is using for lookups; and update the DNS servers with the appropriate end point addresses (e.g., using nsupdate). In embodiments, a DS processing unit could determine the endpoints according to the user ID, proximity/region, a specified storage policy, loads at the DS processing unit, the number of containers on a system, round-robin through a list of available endpoints, etc.

In embodiments, a DS processing unit may batch update for DNS servers and perform updates all at once. Alternatively, a DS processing unit may update the DNS servers when system loads are below a certain threshold, at particular time intervals (e.g., daily, hourly, etc.), etc.

In embodiments, a DS processing unit could delete or update a DNS server, independent of user requests or operator intervention, as network conditions change. For example, a DS processing unit could update a DNS server to point more requests associated with additional buckets through the DS processing unit when the DS processing unit's traffic load is decreased. In embodiments, a DS processing unit could also list containers for a subset of the accounts on the system, and reconcile any DNS entries for existing containers that are DNS compliant.

In situations where external agents (e.g., clients or third parties) are responsible for load balancing and/or request routing, a DS processing unit receiving a request may be configured to update the DNS servers to point to the DS processing unit servicing the external agents' requests, thereby allowing the external agents to directly access certain information, (e.g., load levels at the relevant DS processing unit and the number of containers in the system).

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service deliver for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources, but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure, but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities, but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

As discussed above, aspects of the disclosure may relate to the field of object storage systems, and more particularly to naming containers in a dispersed storage network. Accordingly, an understanding of the embodiments of the present disclosure may be aided by describing examples of a computing environment for an object storage system and an example of a method for implementing embodiments of the present disclosure.

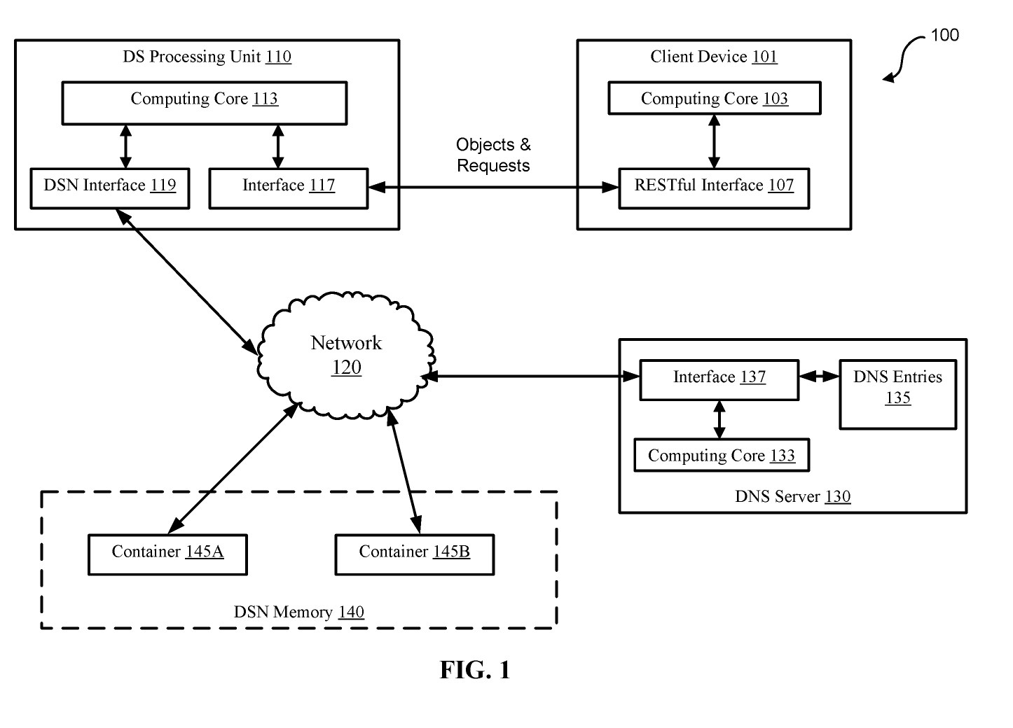

Referring now to FIG. 1, illustrated is a diagram of an example computing environment 100 in which embodiments of the present disclosure may be implemented. Example computing environment 100 may include a client device 101, a DS processing unit 110, a DNS server 130, and a DSN memory 140, communicatively coupled via network 120. In embodiments, RESTful interface 107 of client device 101 may be communicatively coupled to the interface 117 of DS processing unit 110 directly, as shown, or it may be communicatively coupled via network 120.

Network 120 can be implemented using any number of any suitable communications media. For example, the network 120 may be a wide area network (WAN), a local area network (LAN), an internet, or an intranet. For example, the client device 101, DS processing unit 110, DNS server 130, and DSN memory 140 may communicate using a local area network (LAN), one or more hardwire connections, a wireless link or router, or an intranet. In some embodiments, the client device 101, DS processing unit 110, DNS server 130, and DSN memory 140 may be communicatively coupled using a combination of one or more networks and/or one or more local connections. For example, DS processing unit 110 may be hardwired to the DNS server 130 (e.g., connected with an Ethernet cable) while the client device 101 and DSN memory 140 may communicate with the DS processing unit 110 and DNS server 130 using the network 120 (e.g., over the Internet). In some embodiments, DNS server 130 may be hosted on DS processing unit 110.

In some embodiments, the network 120 can be implemented within a cloud computing environment, or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 120.

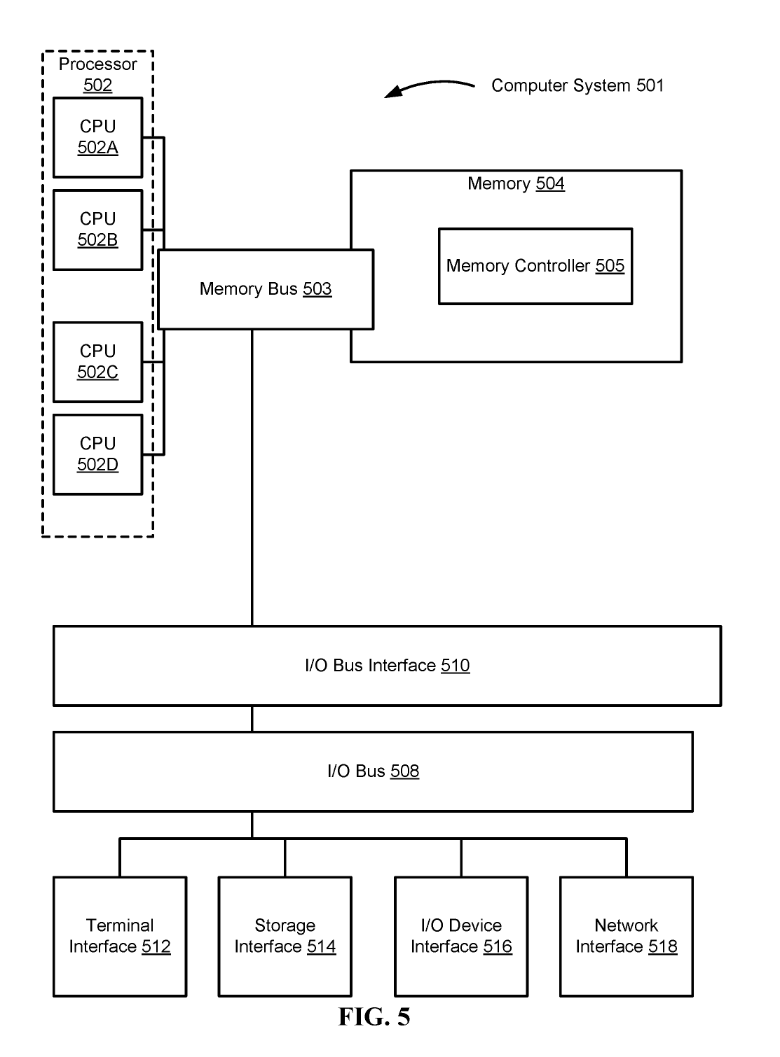

Client device 101 may include a smartphone, tablet, desktop computer, laptop, or any other computing device capable of handling a RESTful interface and communicating with components of an object storage system. In embodiments, client device 101 may include a computing core 103 and a RESTful interface 107. Computing core 103 may be substantially similar to example computer system 501 of FIG. 5.

As described herein, RESTful interface 107 may provide an API between systems using HTTP to obtain data and generate operations on that data in a variety of formats. In other words, RESTful interface 107 may provide a communication bridge between two or more systems running different operating systems and/or applications written in different programming languages. RESTful interface 107 may allow a client/user to submit container creation requests (e.g., PUT BUCKET requests) and other requests, store and retrieve objects, monitor the client-controlled portion of the object storage system, etc. In embodiments, RESTful interface 107 may communicate with an interface 117 of DS processing unit 110.

DS processing unit 110 may include a server or other suitable computer system capable of processing objects and requests among the elements of an object storage system. DS processing unit may include a computing core 113, an interface 117, and a DSN interface 119. In embodiments, computing core 113 may be substantially similar to example computing system 501 of FIG. 5. In embodiments, interface 117 may receive and respond to requests (e.g., PUT, GET, POST, PATCH, DELETE, etc.) from the RESTful interface 107. In embodiments, DSN interface 119 may transmit and receive requests and other data to the other elements of the object storage system (e.g., DSN memory 140, DNS server 130).

DNS server 130 may include computer core 133, interface 137, and DNS entries 135. In embodiments, computing core 133 may be substantially similar to example computing system 501 of FIG. 5. In embodiments, interface 137 may transmit and receive requests and other data to the other elements of the object storage system (e.g., DSN memory 140, DS processing unit 110). In embodiments, DNS entries 135 may include a table, database, or other data storage scheme for mapping/associating IP addresses of containers in a DSN memory system, such as, for example, containers 145A-145B of DSN memory 140.

DSN memory 140 may include storage for an object storage system, such as, for example, containers 145A-145B. In embodiments, DSN memory 140 may include any number of containers 145A-145B. Containers 145A-145B may be located at geographically different sites (e.g., one in Portland, one in London, etc.), at a common site, or a combination thereof. In embodiments, containers 145A-145B may be located on the same storage device. For example, containers 145A-145B may be partitions of a single hard disk drive.

DSN memory 140 may create, delete, or modify containers 145A-145B in response to requests made via a RESTful interface 107, and/or in response to load balancing requests initiated at, for example, DS processing unit 110. Containers 145A-145B may store, and allow access to, objects submitted via RESTful interface 107.

While FIG. 1 illustrates an example computing environment 100 with a single client device 101, a single DS processing unit 120, a single DNS server 130, and a single DSN memory 140, suitable computing environments for implementing embodiments of this disclosure may include any number of client devices, DS processing units, DNS servers and DSN memories. The various models, modules, systems, and components discussed in relation to FIG. 1 may exist, if at all, across a plurality of client devices, DS processing units, DNS servers and DSN memories. For example, some embodiments may include two client devices and multiple DS processing units.

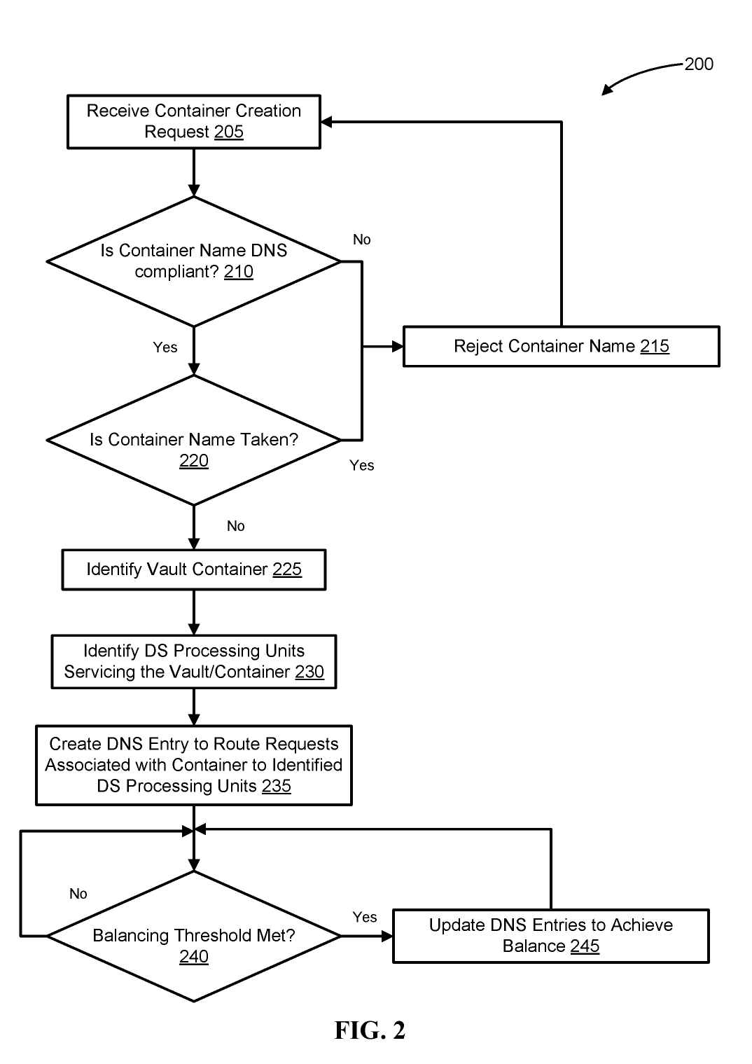

Turning now to FIG. 2, illustrated is a method 200 for enforcing DNS compliant names for container creation and automatic updates, according to an embodiment of the present invention. At 205, a container creation request may be received. A container creation request (e.g., PUT BUCKET request) may be received via, for example, a RESTful interface. In embodiments, the container creation request may be received at a DS processing unit. In embodiments, the container creation request may specify the desired name for the container.

At 210, it may be determined whether the container name is DNS compliant. Different DNS implementations may impose different character and length restrictions. In embodiments, a DS processing unit that receives a container creation request may check the desired container name against the specific DNS implementation's naming policy to determine whether the desired container name is DNS compliant.

If, at 210, it is determined that the desired container name is DNS compliant, it may then be determined, at 220, whether the desired container name is already taken. For example, a DS processing unit that receives a container creation request may query the DNS entries at the DNS server to determine whether the desired container name already exists in the DNS entries.

If, at 210, it is determined that the desired container name is not DNS compliant, or if, at 220, it is determined that the desired container name is already taken, then the container name may be rejected at 215. In embodiments, rejecting the container name may include notifying a client device or end user that the desired container name is either unacceptable, or that the name is already taken. In embodiments, one or more suggestions for available DNS compliant names may be given in conjunction with the rejection.

If, at 220, it is determined that the container name is not taken, then a vault container for hosting the new container may be identified at 225. In embodiments, a vault may include a set of storage resources that may be divided into discrete segments to create containers. In embodiments, a client/user account may have a dedicated vault representing a total storage capacity for that client/user account.

At 230, DS processing units servicing the vault/container may be identified. In embodiments, a given vault or container may have multiple DS processing units routing requests and data thereto.

At 235, a DNS entry (e.g., the DNS compliant container name) may be added to the DNS entries at a DNS server in order to route requests associated with the newly-created container to the set of DS processing units identified at operation 230. Because the container names are DNS compliant, the need to manually update the DNS server to map container IP addresses to container names may be eliminated.

At 240, it may be determined whether a balancing threshold is met. A balancing threshold may contemplate a load threshold (e.g., the number of objects processed by a DS processing unit within a set interval), a utilization threshold (e.g., the amount of storage space used at a container), a processing threshold (e.g., the amount of a DS processing unit's resources that are in use, such as CPU processing pool, memory pool, etc.). In embodiments, thresholds for a given DS processing unit or container may be defined by predetermined numbers, or they may be determined relative to the loads of other DS processing units or containers. For example, a load threshold may be met when a particular DS processing unit processes 2,000 objects within one second; alternatively, a load threshold may be met when any one DS processing unit processes 5% more objects than any other DS processing unit.

In embodiments, object storage system loads may be balanced among DS processing units and/or containers in order to achieve greater system performance. For example, workloads (e.g., requests and data transfers) may be routed to DS processing units (or, in embodiments, to containers) according to the DS processing unit's (or, in embodiments, the container's) proximity to the origin of a particular request, the DS processing unit's pre-existing workload, changes in the set of available DS processing units (e.g., addition/removal of DS processing units), a predetermined storage policy (e.g., round-robin workload assignments, “striping” schemes, etc.)

Implementing embodiments of the present disclosure to enable automatic DNS updates enables more responsive and efficient load balancing, which translates into reduced consumption of computing resources, reduced management costs, and increased performance of object storage systems.

If, at 240, it is determined that a balancing threshold is met, then the DNS entries may be updated at 245 in order to achieve a balanced workload among the DS processing units. This may allow for automatic updates of the DNS entries at times other than container creation or in response to client requests, such as during load balancing. For example, if a particular DS processing unit is experiencing high workloads, DNS entries that would normally point requests to that DS processing unit may be updated to point to another DS processing unit to alleviate the workload imbalance. Balanced workloads may lead to increased performance of the overall object storage system, which may include faster turnaround for client requests, decreased resource consumption, the ability to stagger updates among DS processing units while maintaining client access to containers, etc.

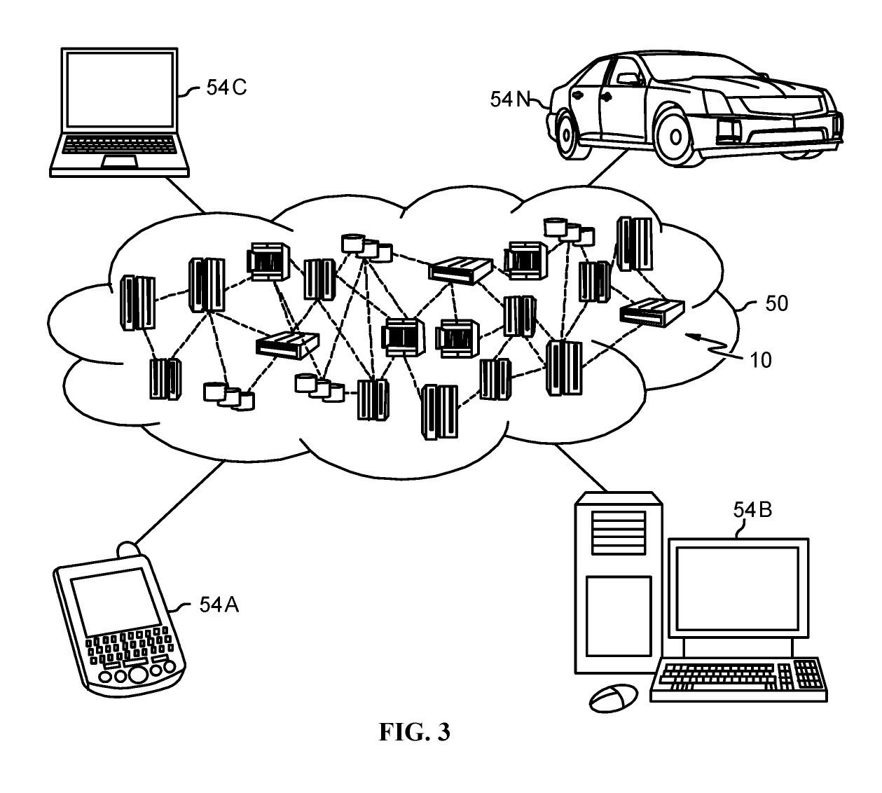

Referring now to FIG. 3, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

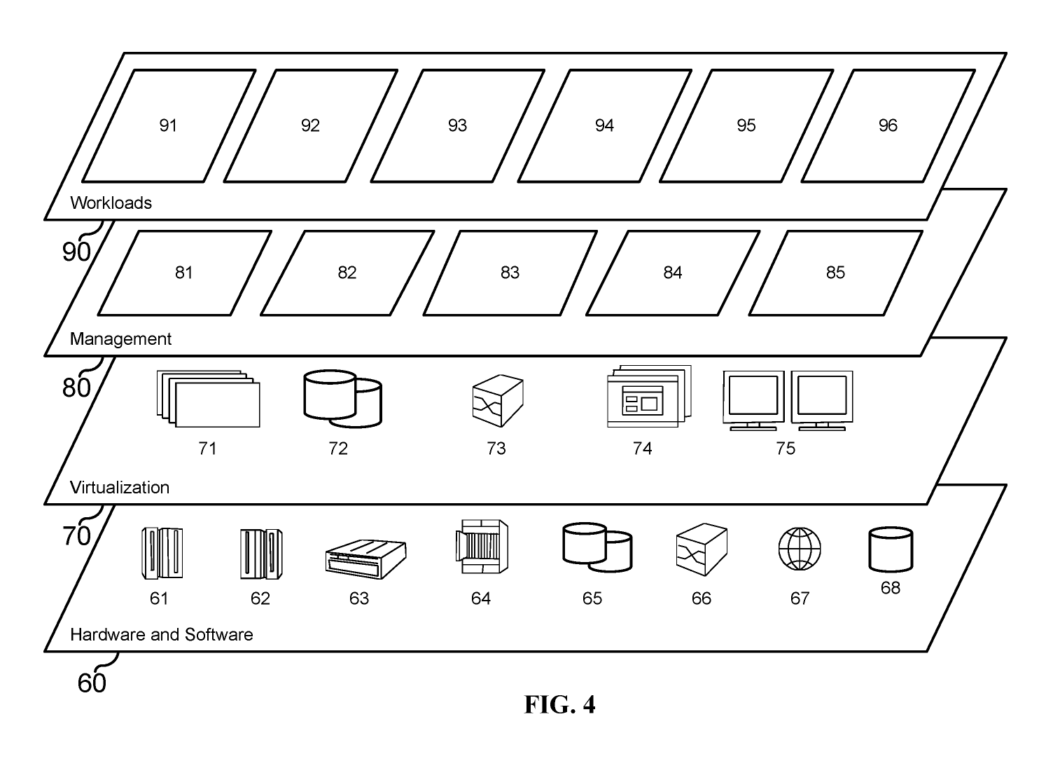

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and enforcing DNS compliant names for object storage system containers 96.

Referring now to FIG. 5, shown is a high-level block diagram of an example computer system (e.g., computer) 501 that may be configured to perform various aspects of the present disclosure, including, for example, method 200, described in FIG. 2. The example computer system 501 may be used in implementing one or more of the methods or modules, and any related functions or operations, described herein (e.g., using one or more processor circuits or computer processors of the computer), in accordance with embodiments of the present disclosure. In some embodiments, the major components of the computer system 501 may comprise one or more CPUs 502, a memory subsystem 504, a terminal interface 512, a storage interface 514, an I/O (Input/Output) device interface 516, and a network interface 518, all of which may be communicatively coupled, directly or indirectly, for inter-component communication via a memory bus 503, an I/O bus 508, and an I/O bus interface unit 510.

The computer system 501 may contain one or more general-purpose programmable central processing units (CPUs) 502A, 502B, 502C, and 502D, herein generically referred to as the CPU 502. In some embodiments, the computer system 501 may contain multiple processors typical of a relatively large system; however, in other embodiments the computer system 501 may alternatively be a single CPU system. Each CPU 502 may execute instructions stored in the memory subsystem 504 and may comprise one or more levels of on-board cache.

In some embodiments, the memory subsystem 504 may comprise a random-access semiconductor memory, storage device, or storage medium (either volatile or non-volatile) for storing data and programs. In some embodiments, the memory subsystem 504 may represent the entire virtual memory of the computer system 501, and may also include the virtual memory of other computer systems coupled to the computer system 501 or connected via a network. The memory subsystem 504 may be conceptually a single monolithic entity, but, in some embodiments, the memory subsystem 504 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 504 may contain elements for control and flow of memory used by the CPU 502. This may include a memory controller 505.

Although the memory bus 503 is shown in FIG. 5 as a single bus structure providing a direct communication path among the CPUs 502, the memory subsystem 504, and the I/O bus interface 510, the memory bus 503 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 510 and the I/O bus 508 are shown as single respective units, the computer system 501 may, in some embodiments, contain multiple I/O bus interface units 510, multiple I/O buses 508, or both. Further, while multiple I/O interface units are shown, which separate the I/O bus 508 from various communications paths running to the various I/O devices, in other embodiments some or all of the I/O devices may be connected directly to one or more system I/O buses.

In some embodiments, the computer system 501 may be a multi-user mainframe computer system, a single-user system, or a server computer or similar device that has little or no direct user interface, but receives requests from other computer systems (clients). Further, in some embodiments, the computer system 501 may be implemented as a desktop computer, portable computer, laptop or notebook computer, tablet computer, pocket computer, telephone, smart phone, mobile device, or any other appropriate type of electronic device.

It is noted that FIG. 5 is intended to depict the representative major components of an exemplary computer system 501. In some embodiments, however, individual components may have greater or lesser complexity than as represented in FIG. 5, components other than or in addition to those shown in FIG. 5 may be present, and the number, type, and configuration of such components may vary.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for performing automatic DNS updates in an object storage system, the method comprising:
receiving a container creation request;
determining that a container name in the container creation request is DNS compliant;
creating one or more DNS entries according to the DNS compliant container name, the creation comprising:
identifying a vault container;
identifying a set of DS processing units servicing the vault container; and
creating DNS entries that point to the set of DS processing units servicing the vault container.

2. The method of claim 1, further comprising:
determining that a load threshold has been met at one or more DS processing units; and
updating DNS entries to balance loads among the set of DS processing units.

3. The method of claim 1, further comprising:
determining that a utilization threshold has been met at one or more containers; and
updating DNS entries to balance utilization among the containers.

4. The method of claim 1, further comprising:
determining that a DS processing threshold has been met for one or more DS processing units; and
updating DNS entries to balance DS processing among the set of DS processing units.

5. The method of claim 1, wherein objects stored in the object storage system are routed to containers based on proximity to the objects' origin.

6. The method of claim 1, wherein the container create request is a PUT BUCKET request received via a REST interface.

7. The method of claim 1, wherein software is provided as a service in a cloud environment to perform the method.

8. A system for performing automatic DNS updates in an object storage system, the system comprising:
a memory with program instructions stored thereon; and
a processor in communication with the memory, wherein the system is configured to perform a method, the method comprising:
receiving a container creation request;
determining that a container name in the container creation request is DNS compliant;
creating one or more DNS entries according to the DNS compliant container name, the creation comprising:
identifying a vault container;
identifying a set of DS processing units servicing the vault container; and
creating DNS entries that point to the set of DS processing units servicing the vault container.

9. The system of claim 8, wherein the method further comprises:
determining that a load threshold has been met at one or more DS processing units; and
updating DNS entries to balance loads among the set of DS processing units.

10. The system of claim 8, wherein the method further comprises:
determining that a utilization threshold has been met at one or more containers; and
updating DNS entries to balance utilization among the containers.

11. The system of claim 8, wherein the method further comprises:
determining that a DS processing threshold has been met for one or more DS processing units; and
updating DNS entries to balance DS processing among the set of DS processing units.

12. The system of claim 8, wherein objects stored in the object storage system are routed to containers based on proximity to the objects' origin.

13. The system of claim 8, wherein the container create request is a PUT BUCKET request received via a REST interface.

14. The system of claim 8, wherein software is provided as a service in a cloud environment to perform the method.

15. A computer program product for performing automatic DNS updates in an object storage system, the computer program product comprising a computer readable storage medium having program instructions embodied therewith, the program instructions executable by a device to cause the device to perform a method, the method comprising:
receiving a container creation request;
determining that a container name in the container creation request is DNS compliant;
creating one or more DNS entries according to the DNS compliant container name, the creation comprising:
identifying a vault container;
identifying a set of DS processing units servicing the vault container; and
creating DNS entries that point to the set of DS processing units servicing the vault container.

16. The computer program product of claim 15, wherein the method further comprises:
determining that a load threshold has been met at one or more DS processing units; and
updating DNS entries to balance loads among the set of DS processing units.

17. The computer program product of claim 15, wherein the method further comprises:
determining that a utilization threshold has been met at one or more containers; and
updating DNS entries to balance utilization among the containers.

18. The computer program product of claim 15, wherein the method further comprises:
determining that a DS processing threshold has been met for one or more DS processing units; and
updating DNS entries to balance DS processing among the set of DS processing units.

19. The computer program product of claim 15, wherein objects stored in the object storage system are routed to containers based on proximity to the objects' origin.

20. The computer program product of claim 15, wherein software is provided as a service in a cloud environment to perform the method.
